(19) United States
(12) Patent Application Publication
(10) Pub. No.: US 2007/0095952 A1
(43) Pub. Date: May 3, 2007

(54) Fuel injector

(76) Inventors: Axel Heinstein, Wimsheim (DE); Axel Storch, Moeglingen (DE); Guido Pilgram, Gundelsheim (DE); Detlef Nowak, Heilbronn (DE); Joerg Heyse, Besigheim (DE); Robert Koehler, Bad Liebenzell/Monakam (DE)

Correspondence Address: KENYON & KENYON LLP, ONE BROADWAY, NEW YORK, NY, 10004, US

(21) Appl. No.: 10/555,516

(22) PCT Filed: Mar. 16, 2004
(86) PCT No.: PCT/DE04/00523

§ 371 Date: Nov. 6, 2006

(30) Foreign Application Priority Data
May 2, 2003 (DE) 103 19 694.3

(51) Int. Cl. F02M 51/00

(52) U.S. Cl. 239/585.1; 239/585.4; 239/900; 239/596; 239/601; 239/552; 239/533.12

(57) ABSTRACT

A fuel injector for the direct injection of fuel into a combustion chamber of an internal combustion engine includes an energizable actuator, a valve needle, which is in operative connection with the actuator and acted upon by a restoring spring in a closing direction to actuate a valve-closure member, which, together with a valve-seat surface formed on a valve-seat body, forms a sealing seat; and includes at least two spray-discharge orifices which are formed in the valve-seat body. At an outer side, facing the combustion chamber of the internal combustion engine, of the valve-seat body, a coating is formed and/or the maximum number of spray-discharge orifices is eight and/or a clearance between the valve-closure member and the valve-seat body is smaller than 20 μm and/or the spray-discharge orifices widen in a spray-discharge direction of the fuel.

### FIELD OF THE INVENTION

The present invention is directed to a fuel injector.

### BACKGROUND INFORMATION

From German Published Patent Application No. 198 04 463, a fuel-injection system for a mixture-compressing internal combustion engine having external ignition is known which includes a fuel injector that injects fuel into a combustion chamber having a piston/cylinder design and a spark plug projecting into the combustion chamber. The fuel injector is provided with at least one row of injection orifices distributed across the circumference of the fuel injector. By selective injection of fuel via the injection orifices a jet-controlled combustion method is implemented by at least one jet in that a mixture cloud is formed.

Particularly disadvantageous in the fuel injector known from the aforementioned printed publication is the deposit formation in the spray-discharge orifices, these deposits clogging the orifices and causing an unacceptable reduction in the flow rate through the injector. This leads to malfunctions of the internal combustion engine.

SUMMARY OF THE INVENTION

In contrast, the fuel injector according to the present invention has the advantage over the related art that a combination of different measures, such as the widening of the spray-discharge orifices in the spray-discharge direction of the fuel, excellent thermal conductivity of the valve-seat body, a reduction in the number of spray-discharge orifices as well as reduced clearance between the valve-closure member and valve-seat body ensure that no deposits due to coking accumulate in the region of the exits of the spray-discharge orifices into the combustion chamber of the internal combustion engine. This prevents malfunctioning of the fuel injector or an impermissible restriction of the fuel flow.

In an advantageous manner, the coating of the valve tip on the side of the combustion chamber or the entire valve-seat body is produced from a highly conductive material such as copper or aluminum.

Furthermore, it is advantageous that the widening in the outlet region of the spray-discharge orifices may have different designs, such as a funnel-type, conical or rectangular shape.

### BRIEF DESCRIPTION OF THE DRAWINGS

FIG. 1 shows a schematic section through an exemplary embodiment of a fuel injector configured according to the present invention, in an overall view.

FIG. 1B shows a schematic section through the discharge-side section of the exemplary embodiment of the fuel injector according to the present invention represented in FIG. 1A, in region 1B in FIG. 1.

FIGS. 2A-B shows a highly schematized representation of a second exemplary embodiment of a fuel injector configured according to the present invention, in the region of the valve-seat body, in two different views.

FIGS. 3A-B shows schematic representations of possible forms of spray-discharge orifices for the fuel injectors configured according to the present invention.

FIGS. 4A-B shows explanatory diagrams of the operating mode of various combinations of the measures according to the present invention.

### DETAILED DESCRIPTION

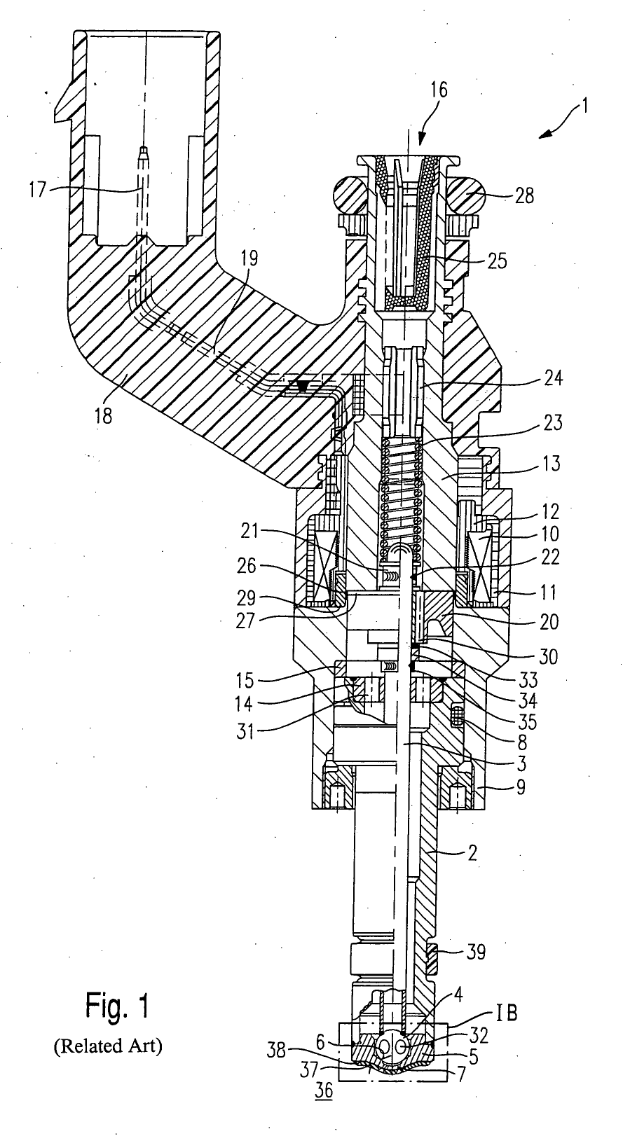

In a part-sectional representation, FIG. 1A shows an exemplary embodiment of a fuel injector 1 designed according to the present invention. It is in the form of a fuel injector 1 for fuel-injection systems of mixture-compressing internal combustion engines having externally supplied ignition. Fuel injector 1 is suited for the direct injection of fuel into a combustion chamber 36 (not shown further) of an internal combustion engine.

Fuel injector 1 is made up of a nozzle body 2 in which a valve needle 3 is positioned. Valve needle 3 is in operative connection with a valve-closure member 4, which cooperates with a valve-seat surface 6 located on a valve-seat member 5 to form a sealing seat. The valve-closure body has a virtually spherical design and thus contributes to an offset-free guidance in valve-seat body 5. In the exemplary embodiment, fuel injector 1 is an inwardly opening fuel injector 1, which has two spray-discharge orifices 7.

Seal 8 seals nozzle body 2 from an outer pole 9 of a solenoid coil 10. Solenoid coil 10 is encapsulated in a coil housing 11 and wound on a coil brace 12, which rests against an inner pole 13 of solenoid coil 10. Inner pole 13 and outer pole 9 are separated from one another by a gap 26 and braced against a connecting member 29. Solenoid coil 10 is energized via a line 19 by an electric current, which may be supplied via an electrical plug contact 17. A plastic extrusion coat 18, which may be extruded onto inner pole 13, encloses plug contact 17.

Valve needle 3 is guided in a valve-needle guide 14, which is disk-shaped. A paired adjustment disk 15 is used to adjust the (valve) lift. On the other side of adjustment disk 15 is an armature 20 which, via a first flange 21, is connected by force-locking to valve needle 3, which is connected to first flange 21 by a welding seam 22. Braced on first flange 21 is a restoring spring 23, which is prestressed by a sleeve 24 in the present design of fuel injector 1.

On the discharge-side of armature 20 is a second flange 31, which is used as lower armature stop. It is connected to valve needle 3 via a welding seam 33 in a force-locking fit. An elastic intermediate ring 32 is positioned between armature 20 and second flange 31 to damp armature bounce during closing of fuel injector 1.

Fuel channels 30 and 31 run inside valve-needle guide 14 and armature 20. Beveled sections 32, which guide the fuel to the sealing seat, are formed on valve-closure member 4. The fuel is supplied via a central fuel supply 16 and filtered by a filter element 25. A seal 28 seals fuel injector 1 from a distributor line (not shown further). Another seal 39 seals with respect to the cylinder head (not shown further) of the internal combustion engine.

According to the present invention, fuel injector 1 has a heat-dissipating coating 38 at an outer side 37 of valve-seat body 5 facing combustion chamber 36 (not shown further) of the internal combustion engine. Spray-discharge orifices 7 discharge through coating 38 in the shape of a funnel, for example. Because of coating 38, heat is dissipated from valve-seat body 5, so that it heats up less, thereby reducing the deposition of fuel and the coking of spray-discharge orifices 7. The discharge-side part of fuel injector 1, which includes coating 38, is shown in greater detail in FIG. 1B. Together with other measures, which will be described in greater detail in the following, the coking of spray-discharge orifices 7 are able to be reduced in an effective manner.

In the rest state of fuel injector 1, restoring spring 23 acts upon first flange 21 on valve needle 3, contrary to its lift direction, in such a way that valve-closure member 4 is retained in sealing contact against valve seat 6. Armature 20 rests on intermediate ring 32, which is supported on second flange 31. When solenoid coil 10 is energized, it builds up a magnetic field which moves armature 20 in the lift direction, counter to the spring tension of restoring spring 23. Armature 20 carries along first flange 21, which is welded to valve needle 3, and thus valve needle 3, in the lift direction as well. Valve-closure member 4, being in operative connection with valve needle 3, lifts off from valve seat surface 6, thereby discharging the fuel guided to spray-discharge orifice 7.

When the coil current is turned off, once the magnetic field has sufficiently decayed, armature 20 falls away from inner pole 13, due to the pressure of restoring spring 23 on first flange 21, whereupon valve needle 3 moves in the direction counter to the lift. As a result, valve closure member 4 comes to rest on valve-seat surface 6, and fuel injector 1 is closed. Armature 20 sets down on the armature stop formed by second flange 31.

In a part-sectional view, FIG. 1B shows the cut-away portion, designated 1B in FIG. 1, from the exemplary embodiment of a fuel injector 1 designed according to the present invention as represented in FIG. 1.

As already indicated in FIG. 1A, valve-seat body 5 has a coating 38 on its outer side 37 facing combustion chamber 36. Because of coating 38, the temperature of valve-seat body 5 is able to be lowered, so that coking thereon caused by fuel deposits is reduced. This keeps spray-discharge orifices 7 free of deposits, which otherwise would clog the flow through fuel injector 1 to an unacceptable degree and make it impossible to operate the internal combustion engine.

Coating 38 may extend across entire surface 34 of valve-seat body 5 or applied only in the region of spray-discharge orifices 7. As an alternative or in addition, instead of a coating 38, valve-seat body 5 may also have a thicker shape, since this measure improves the thermal conductivity of the valve-seat body and thereby also provides for a cooler end face 37. The material thickness should be greater than or equal to 0.4 mm.

Coating 38 may, for instance, be manufactured galvanically on the basis of copper or aluminum, but, as an alternative, it is also possible that entire valve-seat body 5 is made of a material having high thermal conductivity such as copper or aluminum.

Spray-discharge orifices 7 in valve-seat member 5 are able to be implemented as desired. Preferably, they are arranged on a round or elliptical hole circle, which may be concentric or eccentric with respect to a longitudinal axis 40 of valve-seat body 5. The spacing between the hole center points may be equidistant or may differ. The spatial orientation may vary for each hole axis, as indicated in FIG. 1B for two spray-discharge orifices 7.

The fuel jets spray-discharged from spray-discharge orifices 7 can have various opening angles, which depend solely on the geometry of spray-discharge orifice 7. For instance, FIG. 1B shows funnel-shaped exit regions 41 of spray-discharge orifices 7.

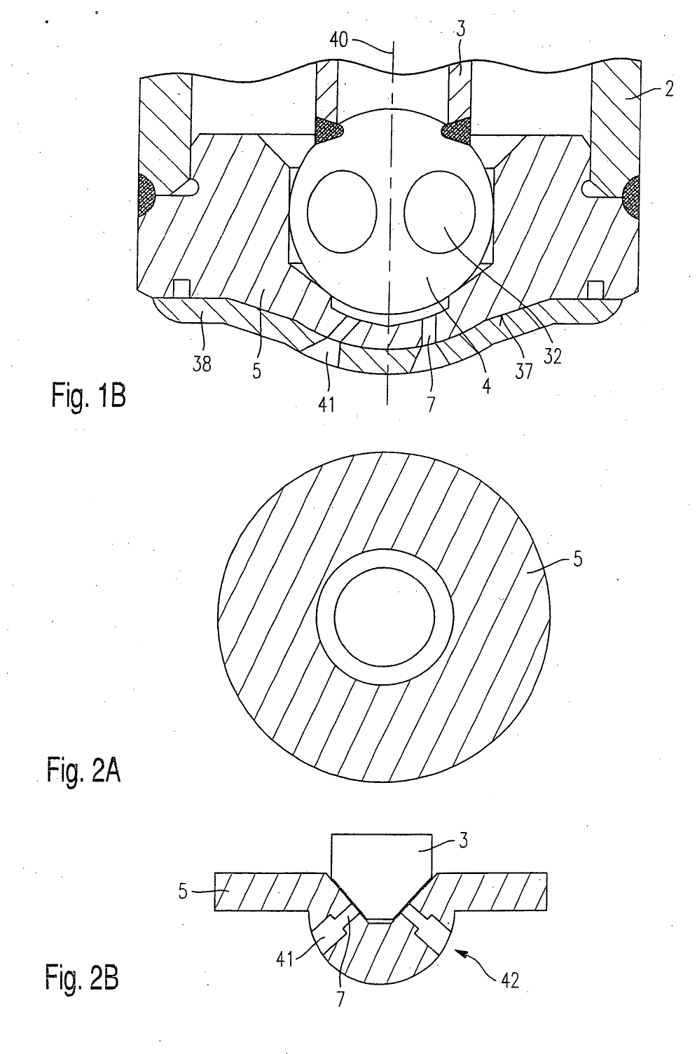

In addition to coating 38, the shape of exit regions 41 of spray-discharge orifices 7 also influences the coking behavior of fuel injector 1. A widened discharge region 41, as shown in FIGS. 1A and 1B, may have a conical, funnel-shaped or stepped design, but also, as shown in FIGS. 2A and 2B in a highly schematized manner, be produced by means of a groove 42, which is implemented on valve-seat body 5 in the region of spray-discharge orifices 7. The widened cross section protects the most narrow measured cross section of spray-discharge orifices 7 from the high combustion temperature and the combustion particles. Deposits, which instead are being formed in the widened cross section, will not interfere with the spray-discharge operation since the deposits, once they grow into the fuel jet, are removed by the fuel jet. The removal is possible due to the fact that the deposit is sufficiently thick and thus rather brittle.

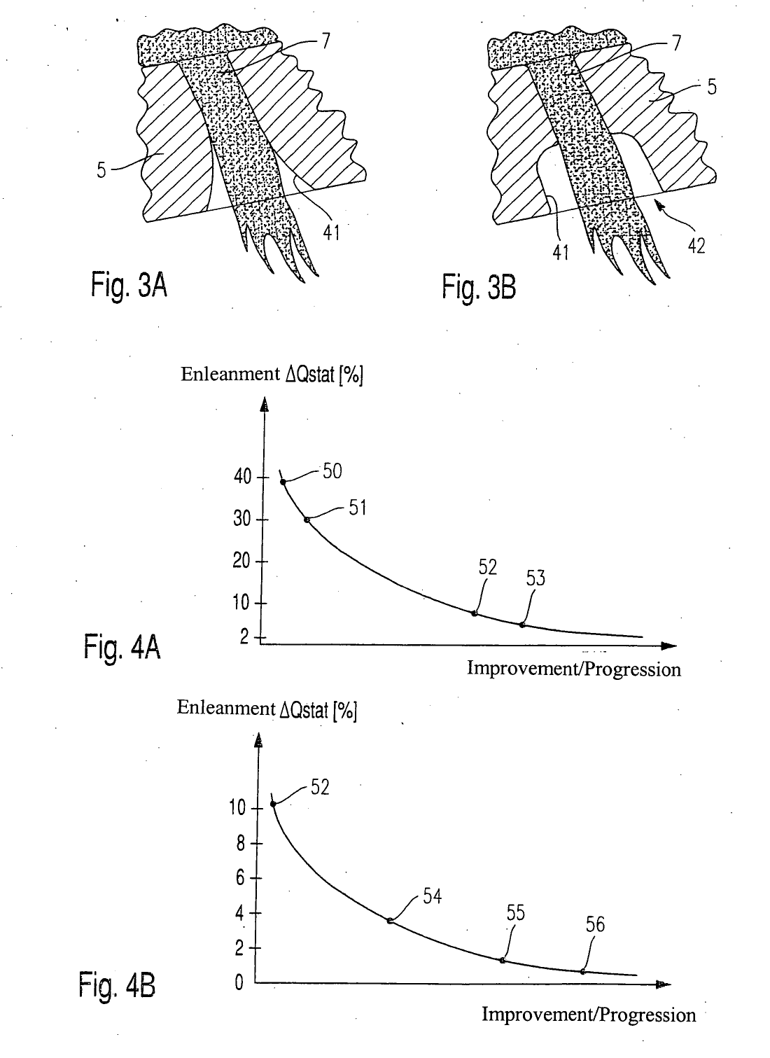

In FIGS. 3A and 3B, spray-discharge orifices 7 and their widened discharge regions 41 are shown by way of example. A form as shown in FIG. 3A is possible in conjunction with coating 38, for instance, described in FIG. 1A and 1B, while the form illustrated in FIG. 3B may be implemented, for instance, by introducing a groove 42 as shown in FIGS. 2A and 2B.

Discharge regions 41 may be introduced in valve-seat body 5 or coating 38 by laser drilling, eroding or similar methods, for instance. Spray-discharge orifices 7 and their discharge regions 41 can be in the shape of a funnel, step or cone. It is also possible to produce discharge regions 41 by means of two-step eroding.

The shape of the sealing seat built from valve-seat surface 6 formed on valve-seat body 5 and valve-closure member 4, also contributes to a temperature reduction in this region. An essential aspect in this context is the distance between the surface of valve-closure member 4 and each spray-discharge orifice 7. A preferred value for this distance is maximally 20 μm. A small clearance allows excellent thermal conductivity, whereas a large clearance would reduce the transfer of heat to cooler valve needle 3. Furthermore, because of the low temperatures achieved in this manner, the fuel below valve-closure member 4 is unable to evaporate, so that the region is protected from the high temperature of the combustion chamber and from deposits of combustion residue. In addition, no sticky evaporation residue is able to form in this region.

Another factor which influences the deposits in the region of spray-discharge orifices 7 is the number of spray-discharge orifices.7. A large number of spray-discharge orifices 7 does cause the mixture cloud to become leaner in the outer regions, but also generates a rich core, which has a high fuel concentration in the interior region of the mixture cloud and thus at valve-closure member 5 as well. To keep the deposits low in the region of spray-discharge orifices 7, a maximum number of eight spray-discharge orifices 7 is advantageous.

Each individual feature has a positive effect on the coking tendency, but only a combination of the various possibilities results in a significant reduction in the deposits in the region of spray-discharge orifices 7. The diagrams in FIGS. 4A and 4B illustrate the effect of various feature combinations in comparison with a fuel injector 1 without the features according to the present invention. The diagrams illustrate the leaning of the metered injection quantity for various mentioned measures and combinations thereof. The x-axis indicates the development improvements achieved by these measures.

The uppermost, left point 50 in diagram 4A represents a fuel injector 1 without the measures according to the present invention. The leaning of the mixture due to coking of spray-discharge orifices 7 amounts to up to 40%.

If valve-seat body 5 is modified in such a way that the clearance between valve-closure member 4 and valve-seat body 5 is reduced, a considerable improvement is achieved already, as illustrated by second point 51 in diagram 4A at approximately 30%.

If the feature of the reduced clearance at the sealing seat is combined with spray-discharge orifices 7 that widen in the spray-discharge direction, third point 52 in diagram 4A is reached, at approximately 10%, which constitutes another considerable improvement.

The combination of a reduced clearance and a lower number of spray-discharge orifices 7 results in another slight improvement in the coking tendency, as indicated by point 53 all the way to the right in diagram 4A. FIG. 4B shows a cut-away section of the diagram illustrated in FIG. 4A, in the range of less than 10% enleanment. For reasons of clarity, third measuring point 52 of FIG. 4A has been transferred to FIG. 4B at an enleamnent of more than 10%.

Additional improvements in the coking tendency are able to be achieved by combining the features of lower clearance and widened spray-discharge orifices 7 with the heat-conducting measures by increasing the wall thickness of valve-seat body 5 (measuring point 54 at barely 4%) or the application of a coating on end face 37 of valve-seat body 5 (measuring point 55 at more than 2%).

A further lowering is still possible by combining the measures of the low clearance and widened spray-discharge orifices 7 with the lower number of spray-discharge orifices 7. The coking tendency is then able to be reduced to a value of close to 1% (measuring point 56).

The present invention is not limited to the exemplary embodiments shown and applicable to arbitrarily arranged spray-discharge orifices 7, for example, and also to any designs of inwardly opening, multi-hole fuel injectors 1.

1.-10. (canceled)

11. A fuel injector for a direct injection of a fuel into a combustion chamber of an internal combustion engine, comprising:
an energizable actuator;
a restoring spring;
a valve-seat surface formed on a valve-seat body, the valve-seat body including at least two spray-discharge orifices;
a valve closure member forming a sealing seat with the valve-seat surface; and
a valve needle that is in operative connection with the actuator and capable of being acted upon in a closing direction by the restoring spring to actuate the valve-closure member, wherein at least one of:
a heat-conducting coating is formed on an outer side of the valve-seat body facing the combustion chamber of the internal combustion engine,
a maximum number of the at least two spray-discharge orifices is eight,
a clearance between the valve-closure member and an inflow cross section of the at least two spray-discharge orifices in the valve-seat body is smaller than 20 μm, and
the at least two spray-discharge orifices widen in a spray-discharge direction of the fuel.

12. The fuel injector as recited in claim 11, wherein the heat-conducting coating includes one of copper and aluminum.

13. The fuel injector as recited in claim 12, wherein the heat-conducting coating is applied on the valve-seat body by galvanization.

14. The fuel injector as recited in claim 12, wherein the valve-seat body includes one of copper and aluminum.

15. The fuel injector as recited in claim 12, wherein a wall thickness of the valve-seat body is at least 0.4 mm.

16. The fuel injector as recited in claim 12, wherein a discharge region of each of the at least two spray-discharge orifices widens in a spray-discharge direction.

17. The fuel injector as recited in claim 16, wherein the discharge region is widened in one of a funnel shape, conically, and in a stepped manner.

18. The fuel injector as recited in claim 11, wherein the at least two spray-discharge orifices end in a groove.

19. The fuel injector as recited in claim 18, wherein the at least two spray-discharge regions in the groove have a rectangular cross section.

20. The fuel injector as recited in claim 11, wherein the at least two spray-discharge orifices are introduced in the valve-seat body by one of eroding, laser drilling, and stamping.
